(19) United States
(12) Patent Application Publication
(10) Pub. No.: US 2023/0373249 A1
(43) Pub. Date: Nov. 23, 2023

(54) TIRE COMPRISING TWO CARCASS LAYERS

(71) Applicant: COMPAGNIE GENERALE DES ETABLISSEMENTS MICHELIN, Clemont-Ferrand (FR)

(72) Inventors: SYLVIE DUCHEMIN, Clermont-Ferrand (FR); BRUNO GUIMARD, Clermont-Ferrand (FR); PIERRE MOUREAU, Clermont-Ferrand (FR)

(21) Appl. No.: 18/030,681

(22) PCT Filed: Oct. 7, 2021
(86) PCT No.: PCT/FR2021/051747

§ 371 Date: Apr. 6, 2023

(30) Foreign Application Priority Data
Oct. 9, 2020 (FR) 2010355
Oct. 9, 2020 (FR) 2010356
Oct. 9, 2020 (FR) 2010359

(51) Int. Cl. B60C 9/02; B60C 9/18

(52) U.S. Cl. CPC B60C 9/02; B60C 9/18; B60C 2200/04

(57) ABSTRACT

The tire (11) for a passenger vehicle comprises a carcass reinforcement (34) anchored in each bead (32). The tire (11) is of the HIGH LOAD CAPACITY type according to the manual of the ETRTO 2021 standard. The tire (11) has a sidewall height H defined by H=SW×AR/100, where SW is the nominal section width and AR the nominal aspect ratio of the tire according to the manual of the ETRTO 2019 standard such that 95≤H≤155. The carcass reinforcement (34) comprises first carcass layer (36) wound around each circumferential reinforcing element and a second carcass layer (37), each end (371, 372) of which is arranged axially between the axially inner portion (3611, 3621) and axially outer portion (3612, 3622) of the first carcass layer (36), or axially on the inside of the axially inner portion (3611, 3621) of the first carcass layer (36).

The present invention relates to a tyre, to a mounted assembly comprising such a tyre, and to a passenger vehicle comprising such a tyre or such a mounted assembly. A tyre is understood to mean a casing intended to form a cavity by cooperating with a support element of the mounted assembly, this cavity being able to be pressurized to a pressure higher than atmospheric pressure. A mounted assembly according to the invention has a structure of substantially toroidal shape exhibiting symmetry of revolution about a main axis of the mounted assembly that coincides with the main axis of the tyre.

The development of electric or hybrid passenger vehicles has caused an increase in the weight of the vehicles, in particular on account of the batteries, which have a relatively high weight substantially proportional to the range of the vehicles. Thus, for example, to increase the range of an electric vehicle, it is necessary to increase the size of the batteries and consequently the weight of the vehicle.

Simply put, it is estimated today that one kilometre of range for an electric motor increases the weight of the vehicle by one kilogram. Thus, in order to achieve a range of 500 kilometres, it is necessary to increase the weight of a combustion engine vehicle by around 500 kg. In order to equip such vehicles, it is necessary to use tyres capable of bearing a very high load.

A tyre for a passenger vehicle, this tyre being capable of bearing a relatively high load, is known from the prior art. This tyre is sold under the MICHELIN™ trade name in the Pilot Sport 4 range and has the size 255/35R18. This tyre has an EXTRA LOAD (abbreviated to XL) version as defined by the manual of the ETRTO 2019 standard and, in this EXTRA LOAD version, has a load index equal to 94. This means that, at a pressure of 290 kPa, the tyre is capable of bearing a load of 670 kg. This load-bearing capacity is relatively high compared with a tyre that has the same size and is designated as STANDARD LOAD (abbreviated to SL), having a load index equal to 90 and capable of bearing a load of 600 kg at a pressure of 250 kPa.

For such a tyre to be placed on the market, it must pass regulatory tests. For example, in Europe, the tyre must pass the load/speed performance test described in Annex VII of UN/ECE Regulation No 30.

However, in its EXTRA LOAD version, and even more so in its STANDARD LOAD version, such a tyre is not capable of bearing the extra load corresponding to the batteries that are necessary for achieving the desired range. Thus, tyre manufacturers have had to propose new solutions in order to meet this new need.

One solution considered by tyre manufacturers is, for a given vehicle, the use of tyres having a larger size, thereby making it possible to bear a greater load. Thus, a given vehicle could be fitted with tyres having a higher load index. For example, a vehicle fitted with the tyres described above in their EXTRA LOAD version could be fitted with tyres of size 275/35R19 in their EXTRA LOAD version, which have a load index equal to 100 and are capable, at a pressure of 290 kPa, of bearing a load of 800 kg, much greater than the load of 670 kg.

Such an increase in the size of the tyres necessarily entails either a reduction in the interior space of the vehicle or an enlargement of the exterior bulk of the vehicle, neither of which is desirable for reasons of roominess and compactness of the vehicle.

Moreover, such an increase in the size of the tyres entails a redesign of the vehicle chassis, and this is not desirable either, for obvious reasons of cost.

Lastly, such an increase in the size of the tyres, in particular the nominal section width, entails an increase in the external noise generated by the tyre and also an increase in the rolling resistance, this also not being desirable in the interests of reducing noise pollution and the energy consumption of the vehicle.

Thus, another solution considered by tyre manufacturers is, for a given size and a given version of a tyre, to increase its recommended inflation pressure. This is because the higher the pressure, the more the tyre is capable of bearing a high load.

However, the use of a relatively high recommended pressure stiffens the tyre and entails a loss of comfort for the passengers of the vehicle, this obviously not being desired by some motor vehicle manufacturers in cases where the comfort of the passengers takes priority over the load that can be borne.

Thus, tyre manufacturers have decided to create a new type of tyre. This new type is now known under the designation HIGH LOAD CAPACITY in the manual of the ETRTO 2021 standard. This new type makes it possible to ensure that the load that the tyre of a given size is capable of bearing is greater than that which a tyre of the same size but in its EXTRA LOAD version would be capable of bearing. For the size 255/35R18, the tyre of the HIGH LOAD CAPACITY type thus has a load index equal to 98, indicating that it is capable of bearing a load of 750 kg at a pressure of 290 kPa.

However, a first problem encountered by tyre manufacturers is the relatively high tensioning of the carcass reinforcement of tyres having relatively high sidewalls, that is to say having a sidewall height greater than or equal to 95, this tensioning being all the more, the greater the load to be borne is.

Moreover, for relatively high sidewalls having a moderately great height, a second problem encountered by manufacturers during the development of a tyre is the dissipation of energy and the temperature in the structure, which can be revealed in particular by the test described in Annex VII of UN/ECE Regulation No 30. Specifically, on increasing the load applied to a tyre so as to simulate the addition of a mass corresponding to the batteries that are necessary for achieving the desired range, a significant increase in the dissipation of energy and a temperature rise in the sidewalls have been observed.

The aim of the invention is to provide a tyre capable of bearing a heavier load than existing tyres without necessarily involving an increase in the recommended tyre pressure, while reducing the tensioning of the carcass reinforcement of the tyre to a reasonable level and the dissipation of energy and the rise in temperature in the sidewalls of the tyre without sacrificing the roominess, compactness and comfort of the vehicle.

Thus, a subject of the invention is a tyre for a passenger vehicle, comprising a crown, two beads, two sidewalls, each connecting each bead to the crown, and a carcass reinforcement anchored in each bead, the crown comprising a crown reinforcement and a tread, the carcass reinforcement extending in each sidewall and in the crown radially on the inside of the crown reinforcement, the tyre being of the HIGH LOAD CAPACITY type according to the manual of the ETRTO 2021 standard, the tyre having a sidewall height H defined by H=SW×AR/100, where SW is the nominal section width and AR the nominal aspect ratio of the tyre according to the manual of the ETRTO 2019 standard such that 95≤H≤155, the carcass reinforcement comprising first and second carcass layers, and the first carcass layer forming a winding around a circumferential reinforcing element of each bead such that an axially inner portion of the first carcass layer is arranged axially on the inside of an axially outer portion of the first carcass layer and such that each axial end of the first carcass layer is arranged radially on the outside of each circumferential reinforcing element, and each axial end of the second carcass layer is arranged radially on the inside of each axial end of the first layer and is arranged:
axially between the axially inner portion and axially outer portion of the first carcass layer, or
axially on the inside of the axially inner portion of the first carcass layer.

According to the invention, the tyre is a tyre for a passenger vehicle. Such a tyre is defined for example in the manual of the ETRTO (European Tyre and Rim Technical Organisation) 2019 standard. Such a tyre has, generally on at least one of the sidewalls, a marking in accordance with the marking in the manual of the ETRTO 2019 standard indicating the size of the tyre in the form X/Y αV U β, where X designates the nominal section width, Y designates the nominal aspect ratio, a designates the structure and may be R or ZR, V designates the nominal rim diameter, U designates the load index and β designates the speed rating.

By increasing the load index of the tyre of the invention relative to the load index of a tyre of the same size in its EXTRA LOAD version, the invention makes it possible to increase the load-bearing capacity of the mounted assembly without modifying the roominess, compactness and comfort of the vehicle on which it is used. Specifically, since the size of the tyre according to the invention is identical to that of the tyre in its EXTRA LOAD version, the mounted assembly does not take up any more space than the tyre in its EXTRA LOAD version. A tyre according to the invention may bear a distinctive marking for distinguishing it from its STANDARD LOAD version and from its EXTRA LOAD version, for example a marking of the type HL (for HIGH LOAD) or XL+ (for EXTRA LOAD+). Such a marking is disclosed in particular in the manual of the ETRTO 2021 standard, page 3 of the section General Notes—Passenger Car Tyres. Examples of sizes of tyres of the HIGH LOAD CAPACITY type are also disclosed in the manual of the ETRTO 2021 standard, page 44, paragraph 9.1 in the section Passenger Car Tyres—Tyres with Metric Designation.

A tyre of the HIGH LOAD CAPACITY type may be characterized by a load index LI such that LI>LI′+1, LI′ being the load index of an EXTRA LOAD tyre of the same size according to the manual of the ETRTO 2019 standard. The load index LI′ is the load index of a tyre of the same size, i.e. having the same nominal section width, the same nominal aspect ratio, the same structure (R and ZR being considered to be identical) and the same nominal rim diameter. The load index LI′ is given in the manual of the ETRTO 2019 standard, specifically in the section entitled Passenger Car Tyres—Tyres with Metric Designation, pages 20 to 41. Depending on the size, it will be the case that LI=LI′+1, LI=LI′+2, LI=LI′+3 or even LI=LI′+4. In the majority of embodiments, LI′+1 LI≥LI′+4, and even LI′+2 LI LI′+4.

As explained above, tyres having a relatively high sidewall height lead to relatively high tensioning of the carcass reinforcement, in particular of the portion of the carcass reinforcement that is anchored in the bead by being wound around the circumferential reinforcing element, this being due to the relatively large volume of inflation gas that they contain compared with a tyre having a relatively low sidewall height. This tensioning is all the greater, the higher the load borne is, this being the case for tyres of the HIGH LOAD CAPACITY type. Thus, it is essential to use two carcass layers, thereby making it possible to significantly reduce the tensioning of each carcass layer.

By limiting the sidewall height of the tyre to sidewall heights H such that 95≤H≤155, the volume of gas is reduced and therefore the tensioning of the carcass reinforcement is reduced to a reasonable level.

Moreover, by virtue of the particular arrangement of the first and second carcass layers, surprisingly, what is obtained is a tyre with optimum energy dissipation and an optimum operating temperature in the sidewall, in particular under high load and at a pressure less than or equal to the recommended pressure for a tyre of the same size in its STANDARD LOAD or EXTRA LOAD version. This is all the more surprising since the particular arrangement of the first and second carcass layers is situated in one region of the tyre, in this case in the bead or in the vicinity of the bead, and this makes it possible to reduce the energy dissipation in another region of the tyre, away from the bead, in this case the sidewall. The inventors have discovered that the particular arrangement of the carcass reinforcement, that is to say the fact that each axial end of the second carcass layer is arranged axially between the axially inner portion and axially outer portion of the first carcass layer, or axially on the inside of the axially inner portion of the first carcass layer, makes it possible to reduce the difference in tension between the first carcass layer and the second carcass layer. As a matter of fact, the smaller the difference in tension between the first and second carcass layers, the less shear stress is generated between these first and second carcass layers and the less energy is dissipated.

For tyres of the HIGH LOAD CAPACITY type having a very high sidewall height, that is to say with HA>55, even though the difference in tension between the first carcass layer and the second carcass layer remains significant, the sidewall height makes it possible to have a relatively large shear area which dissipates energy effectively and which does not require the arrangement of the first and second carcass layers according to the invention.

Thus, for tyres of the HIGH LOAD CAPACITY type having a very high sidewall height such that HA>55, since the tension at the end of the first carcass layer becomes very high, a carcass reinforcement that is not in accordance with the invention should be considered, in which, unlike the arrangement of the invention, each axial end of the second carcass layer is arranged axially on the outside of each axially outer portion of the first carcass layer. With such an arrangement of the carcass reinforcement, the tension at the end of the first carcass layer is reduced to a reasonable level.

Lastly, in contrast to tyres having relatively short sidewalls, that is to say for which H<95, the tyres according to the invention exhibit relatively low compression of the carcass reinforcement on account of their relatively high sidewalls. The risk of premature deterioration of the carcass reinforcement, in particular under high load and at relatively low pressure, is therefore averted despite the presence of two carcass layers.

Each first and second carcass layer is axially delimited by two axial edges of each respective first and second carcass layer and comprises carcass filamentary reinforcing elements extending axially from one axial edge to the other axial edge, respectively, of each first and second carcass layer.

The nominal section width SW and the nominal aspect ratio AR are those indicated by the size marking inscribed on the sidewall of the tyre and in accordance with the manual of the ETRTO 2019 standard.

The tyre according to the invention has substantially toric shape about an axis of revolution substantially coincident with the axis of rotation of the tyre. This axis of revolution defines three directions conventionally used by those skilled in the art: an axial direction, a circumferential direction and a radial direction.

The axial direction is understood to be the direction substantially parallel to the axis of revolution of the tyre or of the mounted assembly, that is to say the axis of rotation of the tyre or of the mounted assembly.

The circumferential direction is understood to be the direction that is substantially perpendicular both to the axial direction and to a radius of the tyre or of the mounted assembly (in other words, tangent to a circle centred on the axis of rotation of the tyre or of the mounted assembly).

The radial direction is understood to be the direction along a radius of the tyre or of the mounted assembly, that is to say any direction that intersects the axis of rotation of the tyre or of the mounted assembly and is substantially perpendicular to that axis.

The median plane of the tyre (denoted M) is understood to be the plane perpendicular to the axis of rotation of the tyre, which is situated axially mid-way between the two beads and passes through the axial middle of the crown reinforcement.

The equatorial circumferential plane of the tyre is understood to be, in a meridian section plane, the plane passing through the equator of the tyre, perpendicular to the median plane and to the radial direction. The equator of the tyre is, in a meridian section plane (plane perpendicular to the circumferential direction and parallel to the radial and axial directions), the axis that is parallel to the axis of rotation of the tyre and situated equidistantly between the radially outermost point of the tread that is intended to be in contact with the ground and the radially innermost point of the tyre that is intended to be in contact with a support, for example a rim.

The meridian plane is understood to be a plane which is parallel to and contains the axis of rotation of the tyre or of the mounted assembly and is perpendicular to the circumferential direction.

Radially inner and radially outer are understood to mean closer to the axis of rotation of the tyre and further away from the axis of rotation of the tyre, respectively. Axially inner and axially outer are understood to mean closer to the median plane of the tyre and further away from the median plane of the tyre, respectively.

A bead is understood to be the portion of the tyre intended to allow the tyre to be attached to a mounting support, for example a wheel comprising a rim. Thus, each bead is notably intended to be in contact with a flange of the rim allowing it to be attached.

Any range of values denoted by the expression “between a and b” represents the range of values extending from more than a to less than b (that is to say excluding the end-points a and b), whereas any range of values denoted by the expression “from a to b” means the range of values extending from a up to b (that is to say including the strict end-points a and b).

In a preferred embodiment, each axial end of the second carcass layer is arranged axially between the axially inner portion and axially outer portion of the first carcass layer.

In certain preferred variants, each axial end of the first carcass layer is arranged radially on the inside of the equator of the tyre and even more preferably arranged at a radial distance of less than or equal to 30 mm from a radially inner end of each circumferential reinforcing element of each bead.

By arranging each axial end of the first carcass layer on the inside of the equator of the tyre, the mass of the carcass reinforcement is significantly reduced. Moreover, the vast majority of rims that are currently used for tyres for passenger vehicles have J-type flanges with a height which, in all cases, is less than 30 mm. The greatly preferred arrangement of each axial end in a region corresponding radially substantially to the rim flange makes it possible to mechanically protect each axial end. Specifically, if each axial end were arranged radially too far above each circumferential reinforcing element of each bead, that is to say at a radial distance strictly greater than 30 mm from the radially inner end of each circumferential reinforcing element, each axial end would then be in a flexible region of the tyre that is subjected to excessive stresses, stresses which are particularly high in the case of a tyre of the HIGH LOAD CAPACITY type.

Preferably, each first and second carcass layer extends in each sidewall and in the crown radially on the inside of the crown reinforcement.

In an embodiment that is optional but nevertheless advantageous, H≤130, preferably H≤120 and more preferably H≤110. By reducing the sidewall height, the tensioning of the end of the first carcass layer is reduced.

Optionally, each first and second carcass layer is axially delimited by two axial edges of the carcass layer and comprises carcass textile filamentary reinforcing elements extending axially from one axial edge to the other axial edge of the carcass layer along a main direction forming an angle ranging from 80° to 90° in terms of absolute value with the circumferential direction of the tyre.

A filamentary element is understood to be an element having a length at least 10 times greater than the greatest dimension of its cross section, irrespective of the shape of the latter: circular, elliptical, oblong, polygonal, in particular rectangular or square or oval. In the case of a rectangular cross section, the filamentary element takes the form of a strip.

Textile is understood to mean a filamentary element comprising one or more textile elementary monofilaments optionally coated with one or more layers of a coating based on an adhesive composition. This or these textile elementary monofilaments is or are obtained, for example, by melt spinning, solution spinning or gel spinning. Each textile elementary monofilament is made from an organic material, in particular a polymeric material, or an inorganic material, for example glass or carbon. The polymeric materials may be of the thermoplastic type, for example aliphatic polyamides, in particular polyamides 6,6, and polyesters, in particular polyethylene terephthalate. The polymeric materials may be of the non-thermoplastic type, for example aromatic polyamides, in particular aramid, and cellulose, either natural or artificial, in particular rayon.

Preferably, each carcass textile filamentary reinforcing element comprises an assembly of at least two multifilament strands having a total count less than or equal to 475 tex.

This is because the presence of two carcass layers makes it possible to reduce the total count of each carcass textile filamentary reinforcing element of each layer, while still having a carcass reinforcement of sufficient mechanical strength.

Optionally, each carcass textile filamentary reinforcing element of each first and second carcass layer has, respectively, an average diameter D1, D2 such that D1≤0.90 mm and D2≤0.90 mm, preferably D1≤0.85 mm and D2≤0.85 mm and more preferably D1≤0.75 mm and D2≤0.75 mm.

Such relatively small diameters D1 and D2 make it possible to limit the initiation of cracks close to the end of each first and second carcass layer. This is because the end of each carcass textile filamentary reinforcing element constitutes a point where cracks are more likely to start, in particular due to the fact that said element lacks any adhesive composition and therefore does not adhere much to the adjacent matrix in which it is embedded. Reducing each diameter D1, D2 reduces the surface area of the end and therefore the risk of the initiation of cracks. Likewise optionally, D1 and D2 are such that D1≥0.55 mm and D2≥0.55 mm, preferably D1≥0.60 mm and D2≥0.60 mm.

The counts (or linear density) of each strand and filamentary reinforcing element are determined according to the 2014 standard ASTM D 885/D 885M-10a. The count is given in tex (weight in grams of 1000 m of product—as a reminder: 0.111 tex is equal to 1 denier).

The diameter of each carcass textile filamentary reinforcing element is the diameter of the smallest circle in which the carcass textile filamentary reinforcing element is circumscribed. The average diameter is the average of the diameters of the carcass textile filamentary reinforcing elements situated along a length of 10 cm of each carcass layer.

Each multifilament strand is selected from a polyester multifilament strand, an aromatic polyamide multifilament strand and an aliphatic polyamide multifilament strand, preferably each multifilament strand is selected from a polyester multifilament strand and an aromatic polyamide multifilament strand.

A polyester multifilament strand is understood to be a multifilament strand made up of monofilaments of linear macromolecules formed of groups held together by ester bonds. Polyesters are produced by polycondensation by esterification between a dicarboxylic acid, or one of its derivatives, and a diol. For example, polyethylene terephthalate can be produced by polycondensation of terephthalic acid and ethylene glycol. Among the known polyesters, polyethylene terephthalate (PET), polyethylene naphthalate (PEN), polybutylene terephthalate (PBT), polybutylene naphthalate (PBN), polypropylene terephthalate (PPT) or polypropylene naphthalate (PPN) may be mentioned.

An aromatic polyamide multifilament strand is understood to be a multifilament strand made up of monofilaments of linear macromolecules formed of aromatic groups held together by amide bonds, at least 85% of which are directly linked to two aromatic rings, and more particularly poly(p-phenylene terephthalamide) (or PPTA) fibres, which have been produced for a very long time from optically anisotropic spinning compositions. Among the aromatic polyamides, polyarylamides (or PAA, known in particular under the trade name Ixef from the company Solvay), poly(metaxylylene adipamide), polyphthalamides (or PPA, known in particular under the trade name Amodel from the company Solvay), amorphous semiaromatic polyamides (or PA 6-3T, known in particular under the trade name Trogamid from the company Evonik), or para-aramids (or poly(paraphenylene terephthalamide or PA PPD-T, known in particular under the trade name Kevlar from the company Du Pont de Nemours or the trade name Twaron from the company Teijin) may be mentioned.

An aliphatic polyamide multifilament strand is understood to be a multifilament strand made up of monofilaments of linear macromolecules of polymers or copolymers containing amide functions which do not have aromatic rings and which can be synthesized by polycondensation between a carboxylic acid and an amine. Among the aliphatic polyamides, nylons PA4.6, PA6, PA6.6 or PA6.10, and in particular Zytel from the company DuPont, Technyl from the company Solvay or Rilsamid from the company Arkema may be mentioned.

Very preferably, the assembly is chosen from an assembly of two polyester multifilament strands and an assembly of a polyester multifilament strand and an aromatic polyamide multifilament strand.

In preferred embodiments, the tyre has a nominal section width SW ranging from 225 to 315, a nominal aspect ratio ranging from 25 to 55, a nominal rim diameter ranging from 18 to 23 and a load index LI ranging from 98 to 116, preferably a nominal section width SW ranging from 245 to 315, a nominal aspect ratio ranging from 30 to 45, a nominal rim diameter ranging from 18 to 23 and a load index LI ranging from 98 to 116. As explained above, the tyres according to the invention are intended to bear relatively high loads, inevitably leading to relatively high wear compared with tyres of the same sizes in their EXTRA LOAD version. Thus, it is particularly advantageous to use tyres which have a relatively large nominal section width in order to reduce the pressure exerted on the tread and therefore the wear.

Advantageously, 0.88≤H/LI≤0.98. Thus, the invention is preferably applied to tyres that are likely to have relatively significant deflection because they have a relatively high load index for a given sidewall height, that is to say one satisfying H/LI≤0.98. This is made possible by the particular arrangement of the carcass reinforcement, which makes it possible to reduce energy dissipation despite significant deflection of the sidewall. However, if the sidewall is too short in relation to the load index, i.e. satisfying H/LI<0.88, the deflection of the sidewall leads to relatively high compression of the first carcass layer and therefore an increase in energy dissipation.

Particularly preferred embodiments are those in which the tyre has a size and a load index LI chosen from the following sizes and load indexes: 225/55R18 105, 225/55ZR18 105 205/55R19 100, 205/55ZR19 100, 235/45R21 104, 235/45ZR21 104, 285/45R22 116, 285/45ZR22 116, 245/40R19 101, 245/40ZR19 101, 255/40R20 104, 255/40ZR20 104, 245/40R21 103, 245/40ZR21 103, 255/40R21 105, 255/40ZR21 105, 265/40R21 108, 265/40ZR21 108, 255/40R22 106, 255/40ZR22 106, 275/35R21 105, 275/35ZR21 105, 285/35R21 108, 285/35ZR21 108, 295/35R22 111, 295/35ZR22 111, 275/35R23 108, 275/35ZR23 108, 325/30R21 111, 325/30ZR21 111.

In some embodiments, the crown reinforcement comprises a working reinforcement comprising a radially inner working layer and a radially outer working layer arranged radially on the outside of the radially inner working layer.

In some embodiments, each working layer is axially delimited by two axial edges of said working layer and comprises working filamentary reinforcing elements extending axially from one axial edge to the other axial edge of said working layer, substantially parallel to one another.

Optionally, each working filamentary reinforcing element extends along a main direction forming an angle which, in terms of absolute value, is strictly greater than 10°, preferably ranging from 15° to 50° and more preferably ranging from 20° to 35°, with the circumferential direction of the tyre.

Preferably, in the embodiments in which the working reinforcement comprises a radially innermost working layer and a radially outermost working layer arranged radially on the outside of the radially innermost layer, the main direction along which each working filamentary reinforcing element of the radially innermost working layer extends and the main direction along which each working filamentary reinforcing element of the radially outermost working layer extends form oppositely oriented angles with the circumferential direction of the tyre.

Optionally, the crown reinforcement comprises a hoop reinforcement that is axially delimited by two axial edges of the hoop reinforcement and comprises at least one hooping filamentary reinforcing element wound circumferentially in a helix so as to extend axially between the axial edges of the hoop reinforcement.

Preferably, the hoop reinforcement is arranged radially on the outside of the working reinforcement.

Preferably, the or each hooping filamentary reinforcing element extends along a main direction forming an angle which, in terms of absolute value, is less than or equal than 10°, preferably less than or equal to 7° and more preferably less than or equal to 5°, with the circumferential direction of the tyre.

A further subject of the invention is a mounted assembly comprising:
a mounting support comprising a rim, and
a tyre as defined above, mounted on the rim.

Advantageously, with the crown reinforcement being arranged radially between the tread and the carcass reinforcement and comprising a working reinforcement comprising at least one axially narrowest working layer, the axially narrowest working layer having an axial width T2 expressed in mm, and the rim having a rim width A according to the manual of the ETRTO 2019 standard and expressed in mm, the ratio T2/A is such that T2/A≤1.00.

In order to control energy dissipation and the temperature in the structure during operation of the tyre according to the invention, it is preferable to ensure that the axial width of the axially narrowest working layer has the correct size in relation to the width of the rim. This is because, in the case of a high load greater than that known from the prior art, the deflection of the tyre, that is to say the difference between the radius of the mounted assembly without load and the radius of the mounted assembly under that load, is considerably increased. This increase in deflection leads to relatively high energy dissipation and a relatively large rise in temperature in the structure of the tyre, in particular in the bead.

In order to control this, it will be preferred to straighten the sidewall of the tyre, that is to say make the sidewall straighter in the radial direction, with the aim of increasing the radial stiffness of the tyre so as to avoid excessive deflection of the tyre and increased energy dissipation and a rise in temperature in the structure of the tyre. It is thus recommended to reduce the ratio T2/A to a value less than or equal to 1.00 in order:
for a given rim width A, to reduce the axial width T2 of the axially narrowest working layer, thereby resulting in a reduction in the width of the contact patch and therefore radial straightening of the sidewall of the tyre,
for an axial width T2 of the given axially narrowest working layer, to increase the rim width A, thereby also resulting in radial straightening of the sidewall of the tyre.

If a person skilled in the art changes the axial width T2 of the axially narrowest working layer, they will adapt the characteristics of the crown of the tyre, in particular those of the crown reinforcement comprising the working reinforcement and any hoop reinforcement, and those of the tread, depending on the axial width T2 they have determined.

In both cases, the radial stiffness of the tyre is increased, and therefore the deflection of the tyre is reduced for a given load, which makes it possible to at least partially offset the impact of the increase in the load, and the stresses exerted on the structure of the tyre are thus reduced, as are therefore the energy dissipation and the rise in temperature during operation of the tyre.

In order to limit the increase in the masses in rotation on the vehicle but also in order to reduce the space taken up by the mounted assembly to the benefit of roominess and compactness of the vehicle, preference will be given to reducing the axial width T2 of the axially narrowest working layer rather than increasing the rim width A. The axial width of the axially narrowest working layer is measured on a tyre section in a meridian plane and corresponds to the width in the axial direction between the two axial ends of the working layer.

Preferably, the axially narrowest working layer is the radially outer working layer of the working reinforcement.

In embodiments that are likewise advantageous, 0.85≤T2/A, preferably 0.90≤T2/A, and more preferably 0.93≤T2/A≤0.97.

It is preferable to have a ratio T2/A that is not too low. Specifically, for a given rim width A, it is preferable to not excessively reduce the value of the axial width T2 of the axially narrowest working layer, as this risks reducing the edgewise bending stiffness and therefore the cornering stiffness when there is a high amount of cornering. Moreover, if the value of the axial width T2 of the axially narrowest working layer is reduced too much, the width of the contact patch is reduced, thereby increasing the pressure exerted on the tread and therefore the wear, this wear being amplified by the fact that the tyres according to the invention are intended to bear relatively high loads, inevitably leading to high wear, in any case wear that is higher than for tyres of the same size in their EXTRA LOAD version which are required to bear smaller loads. For an axial width T2 of the given axially narrowest working layer, it is also preferable to not increase the value of the rim width A too much in order, as explained above, to limit the increase in the masses in rotation on the vehicle but also in order to reduce the space taken up by the mounted assembly to the benefit of the roominess and compactness of the vehicle.

In preferred embodiments, the tyre has a nominal section width SW such that T2≥SW−75, preferably T2≥SW−70. For a given nominal section width, the axially narrowest working layer which primarily defines the width of the contact patch is not too small. Specifically, as explained above, this makes it possible to maintain good tyre wear performance despite the fact that the tyres according to the invention are intended to bear relatively high loads, inevitably leading to relatively high wear.

In preferred embodiments, the tyre has a nominal section width SW such that T2≥SW−27, preferably T2≤SW−30.

In these embodiments, as in the invention in general, the nominal section width is that indicated by the size marking inscribed on the sidewall of the tyre.

In order to reduce the risk of the tyre being mounted on a rim with a rim width that would be too small and would cause a relatively high degree of bending of the shoulder of the tyre, preference will be given to limiting the rims that can be used with the tyre. Thus, the rim is chosen from:
a rim having a rim width code equal to the measuring rim width code for the size of the tyre and defined according to the manual of the ETRTO 2019 standard, and
a rim having a rim width code equal to the measuring rim width code for the size of the tyre minus 0.5, and
a rim having a rim width code equal to the measuring rim width code for the size of the tyre plus 0.5.

The measuring rim is defined in particular on pages 20 to 41 of the section Passenger Car Tyres—Tyres with Metric Designation in the manual of the ETRTO 2019 standard.

Preferably, in order to limit the increase in the masses in rotation on the vehicle but also to reduce the space taken up by the mounted assembly to the benefit of the roominess and compactness of the vehicle, the rim has a rim width code equal to the measuring rim width code for the size of the tyre minus 0.5.

Advantageously, the tyre is inflated to a pressure ranging from 200 to 350 kPa, preferably from 250 to 330 kPa. The pressure is that of the mounted assembly at 25° C. without the tyre having been run. It often corresponds to one of the inflation pressures recommended by motor vehicle manufacturers.

For uses in which it is desired to prioritize the load-bearing capacity of the tyre, a relatively high pressure, greater than or equal to 270 kPa, will be used.

For uses in which it is desired to prioritize the comfort of the passengers and the behaviour of the vehicle, in particular grip on dry ground, a relatively low pressure, less than or equal to 270 kPa, will be used.

A further subject of the invention is a passenger vehicle comprising at least one tyre or a mounted assembly as defined above.

The invention will be understood better on reading the following description, which is given purely by way of non-limiting example and with reference to the drawings, in which:

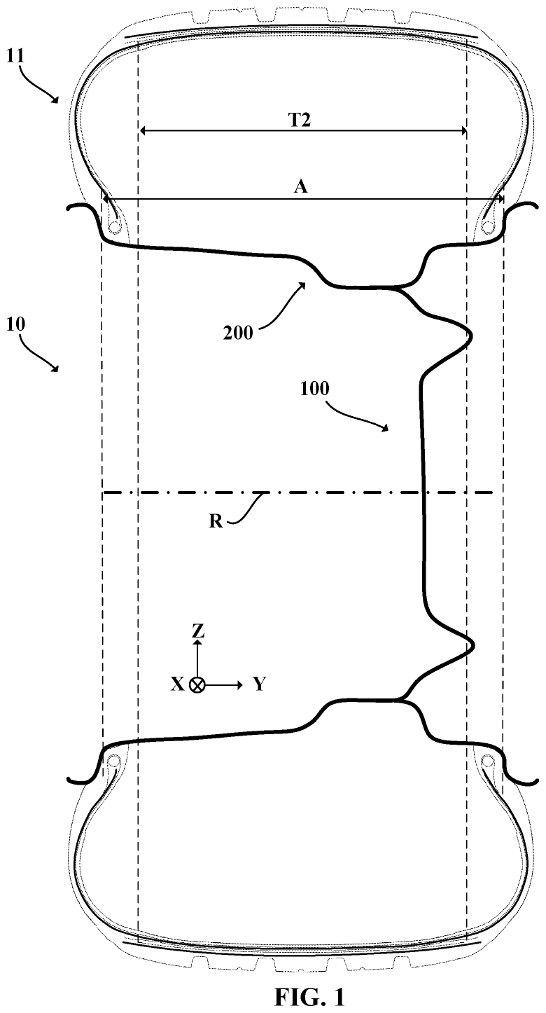

FIG. 1 is a view, in a meridian section plane, of a mounted assembly according to a first embodiment of the invention,

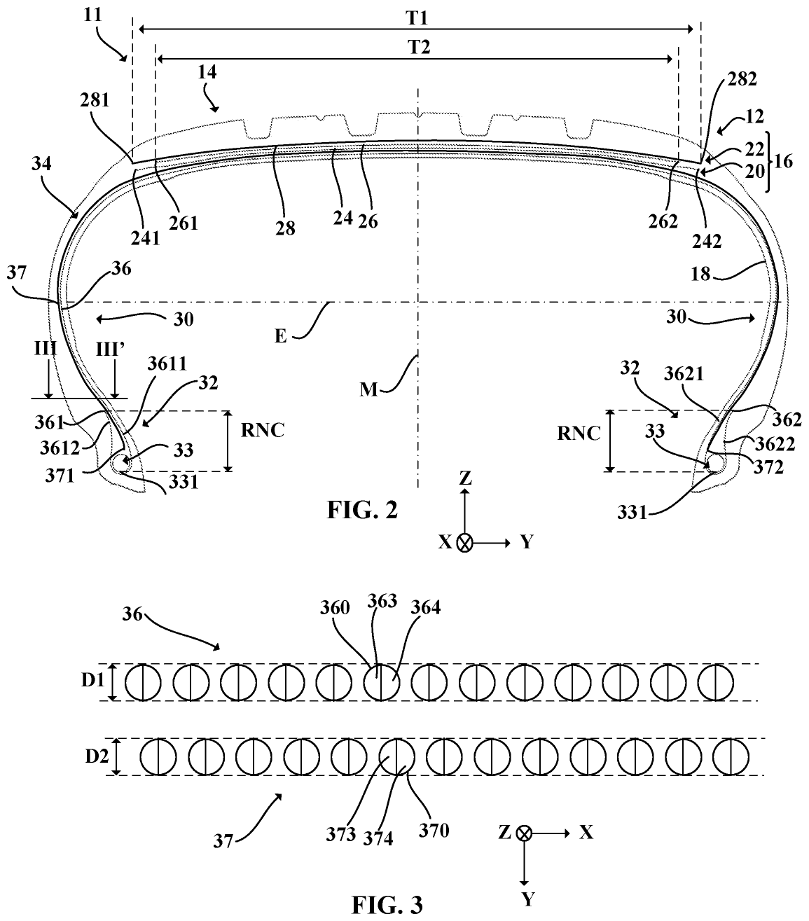

FIG. 2 is a view, in a meridian section plane, of the tyre of the mounted assembly in FIG. 1,

FIG. 3 is a view in section on the plane III-III′ in FIG. 2 illustrating the carcass reinforcement of the tyre in FIG. 1, and

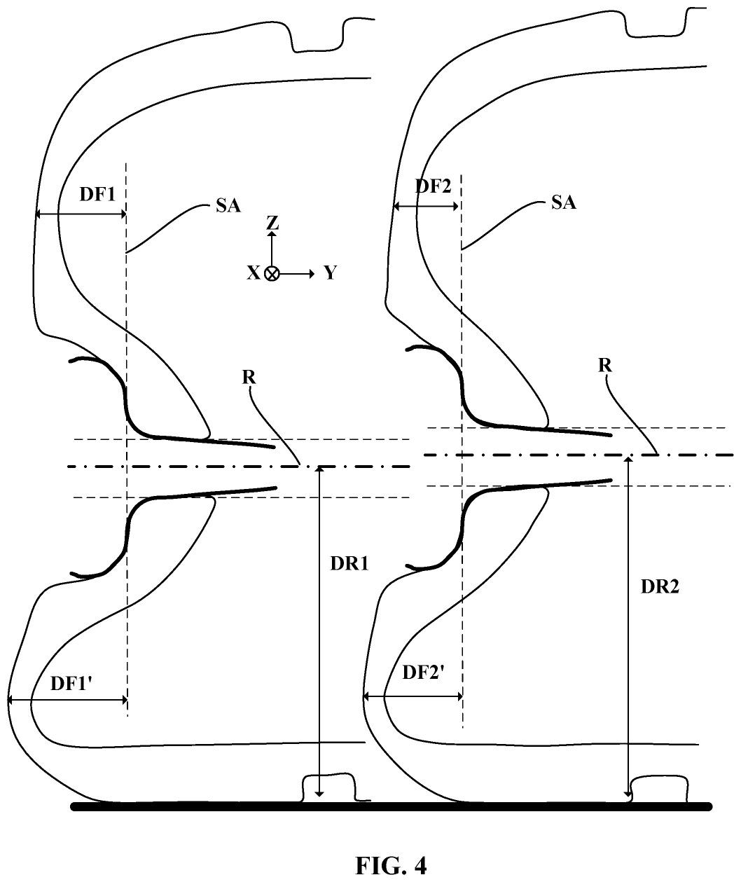

FIG. 4 is a view similar to the one in FIG. 1 comparing the deflection of a mounted assembly of the prior art and that of the mounted assembly in FIG. 1.

A frame of reference X, Y, Z corresponding to the usual axial (Y), radial (Z) and circumferential (X) directions, respectively, of a tyre or of a mounted assembly is shown in the figures.

In the following description, the measurements taken are taken on an unladen and non-inflated tyre or on a section of a tyre in a meridian plane.

FIG. 1 shows a mounted assembly according to the invention, denoted by the general reference 10. The mounted assembly 10 comprises a tyre 11 and a mounting support 100 comprising a rim 200. The tyre 11 is in this case inflated to a pressure ranging from 200 to 350 kPa, preferably from 250 to 330 kPa and in this case equal to 270 kPa.

The tyre 11 has a substantially toric shape about an axis of revolution R substantially parallel to the axial direction Y. The tyre 11 is intended for a passenger vehicle. In the various figures, the tyre 11 is depicted as new, i.e. when it has not yet been run.

The tyre 11 comprises two sidewalls 30 bearing a marking indicating the size of the tyre 11, and also a speed rating and a speed code. In this instance, the tyre 11 has a nominal section width SW ranging from 225 to 315, preferably ranging from 245 to 315 and in this case equal to 255. The tyre 11 also has a nominal aspect ratio AR ranging from 25 to 55 and in this case equal to 40. The tyre 11 has a nominal rim diameter ranging from 18 to 23 and in this case equal to 21. The tyre 11 therefore has a sidewall height H defined by SW x AR/100=102 which is greater than or equal to 95 and less than or equal to 155, preferably less than or equal to 130, more preferably less than or equal to 120 and in this case less than or equal to 110.

In accordance with the invention, the marking also comprises a load index LI ranging from 98 to 116, such that LI≥LI′+1 with LI′ being the load index of an EXTRA LOAD tyre of the same size according to the manual of the ETRTO 2019 standard. Preferably, LI′+1≤LI≤LI′+4, and even LI′+2 LI≥LI′+4.

A tyre of size 255/40R21 in its EXTRA LOAD version has a load index equal to 102, as indicated on page 34 of the section Passenger Car Tyres—Tyres with Metric Designation of the manual of the ETRTO 2019 standard. Thus, the load index LI of the tyre 11 is such that LI≥103, preferably 103≤LI≤106 and even 104≤LI≤106, and in this case LI=105. This load index equal to 105 corresponds to the load index of a HIGH LOAD CAPACITY tyre of size 255/40R21, as indicated in the ETRTO 2021 manual. Thus, the tyre 11 is clearly of the HIGH LOAD CAPACITY type.

The tyre 11 is such that 0.88≤H/LI≤0.98 and in this case H/LI=0.97.

For such a size, the manual of the ETRTO 2019 standard indicates, on page 34 of the section Passenger Car Tyres—Tyres with Metric Designation, a measuring rim having a rim width code equal to 9. The rim 200 of the mounted assembly 10 is thus selected from:
a rim having a rim width code equal to the measuring rim width code for the size of the tyre and defined according to the manual of the ETRTO 2019 standard, and
a rim having a rim width code equal to the measuring rim width code for the size of the tyre minus 0.5, and
a rim having a rim width code equal to the measuring rim width code for the size of the tyre plus 0.5.

In this case, the rim 200 of the mounted assembly 10 is the rim having a rim width code equal to the measuring rim width code for the size of the tyre minus 0.5 and therefore in this case equal to 8.5. The rim 200 has a profile of type J and a rim width A according to the manual of the ETRTO 2019 standard. In this instance, with the profile of the rim 200 being of type 8.5 J, its rim width A expressed in mm is equal to 215.90 mm.

With reference to FIG. 2, the tyre 11 comprises a crown 12 comprising a tread 14 intended to come into contact with the ground when the tyre is running and a crown reinforcement 16 extending in the crown 12 in the circumferential direction X. The tyre 11 also comprises a layer 18 that is airtight with respect to an inflation gas and is intended to delimit an internal cavity closed with the mounting support 100 for the tyre 11 once the tyre 11 has been mounted on the mounting support 100.

The crown reinforcement 16 comprises a working reinforcement 20 and a hoop reinforcement 22. The working reinforcement 16 comprises at least one working layer and in this case comprises two working layers comprising a radially inner working layer 24 arranged radially on the inside of a radially outer working layer 26. Of the radially inner layer 24 and the radially outer layer 26, the axially narrowest layer is the radially outer layer 26.

The hoop reinforcement 22 comprises at least one hooping layer and in this case comprises one hooping layer 28.

The crown reinforcement 16 is surmounted radially by the tread 14. In this case, the hoop reinforcement 22, in this case the hooping layer 28, is arranged radially on the outside of the working reinforcement 20 and is therefore interposed radially between the working reinforcement 20 and the tread 14.

The two sidewalls 30 extend the crown 12 radially towards the inside. The tyre 11 also has two beads 32 radially on the inside of the sidewalls 30. Each sidewall 30 connects each bead 32 to the crown 12.

The tyre 11 comprises a carcass reinforcement 34 that is anchored in each bead 32 and, in this instance, forms a winding around a circumferential reinforcing element 33, in this case a bead wire. The carcass reinforcement 34 extends radially in each sidewall 30 and axially in the crown 12, radially on the inside of the crown reinforcement 16. The crown reinforcement 16 is arranged radially between the tread 14 and the carcass reinforcement 34. The carcass reinforcement 34 comprises at least one carcass layer 36 and in this case first and second carcass layers 36, 37. Each first and second carcass layer 36, 37 extends in each sidewall 30 and in the crown 12 radially on the inside of the crown reinforcement 16.

The hoop reinforcement 22, in this case the hooping layer 28, is axially delimited by two axial edges 281, 282 and comprises one or more hooping filamentary reinforcing elements that are wound circumferentially in a helix between each axial edge 281, 282 along a main direction forming an angle AF which, in terms of absolute value, is less than or equal to 10°, preferably less than or equal to 7° and more preferably less than or equal to 5° with the circumferential direction X of the tyre 10. In this case, AF=−5°.

Each radially inner working layer 24 and radially outer working layer 26 is axially delimited by two axial edges 241, 242, 261, 262, respectively, of each working layer 24, 26. The radially inner working layer 24 has an axial width T1=224.00 mm and the radially outer working layer 26 has an axial width T2=210.00 mm, making the radially outer working layer 26 the axially narrowest working layer.

Note that SW=255 and T2=210.00 satisfy the following relationships T2≥SW−75, preferably T2≥SW−70 and T2≤SW−27, preferably T2≤SW−30.

As illustrated in FIG. 1, the mounted assembly 10 is such that the tyre 11 has radially straightened sidewalls. Specifically, the ratio T2/A is such that 0.85≤T2/A≤1.00, preferably 0.90≤T2/A≤1.00, and more preferably 0.93≤T2/A≤0.97 and in this case T2/A=0.97.

Each working layer 24, 26 comprises working filamentary reinforcing elements extending axially from one axial edge 241, 261 to the other axial edge 242, 262 of each working layer 24, 26, substantially parallel to one another along main directions forming oppositely oriented angles AT1 and AT2, respectively, which, in terms of absolute value, are strictly greater than 10°, preferably ranging from 15° to 50° and more preferably ranging from 20° to 35°, with the circumferential direction X of the tyre 10. In this case, AT1=−26° and AT2=+26°.

Each first and second carcass layer 36, 37 is axially delimited by two axial edges 361, 362, 371, 372, respectively, and comprises carcass textile filamentary reinforcing elements 360, 370, respectively, extending axially from one axial edge 361, 371 to the other axial edge 362, 372 along a main direction D3 forming an angle AC which, in terms of absolute value, ranges from 80° to 90°, and in this case AC=+90°, with the circumferential direction X of the tyre 10.

The first carcass layer 36 forms a winding around each circumferential reinforcing element 33 of each bead 32 such that an axially inner portion 3611, 3621 of the first carcass layer 36 is arranged axially on the inside of an axially outer portion 3612, 3622 of the first carcass layer 36 and such that each axial end 361, 362 of the first carcass layer 36 is arranged radially on the outside of each circumferential reinforcing element 33. Each axial end 371, 372 of the second carcass layer 37 is arranged radially on the inside of each axial end of the first layer 361, 362 and is arranged axially between the axially inner and outer portions 3611, 3612 and 3621, 3622 of the first carcass layer 36.

Each axial end 361, 362 of the first carcass layer 36 is arranged radially on the inside of the equator E of the tyre. More specifically, each axial end 361, 362 of the first carcass layer 36 is arranged at a radial distance RNC of less than or equal to 30 mm from a radially inner end 331 of each circumferential reinforcing element 33 of each bead 32. In this case, RNC=23 mm.

Each working layer 24, 26, hooping layer 28 and carcass layer 36 comprises a calendering matrix for the filamentary reinforcing elements of the corresponding layer. Preferably, the calendering matrix is polymeric and more preferably elastomeric, like those usually used in the field of tyres.

Each hooping filamentary reinforcing element conventionally comprises two multifilament strands, each multifilament strand being made up of a spun yarn of aliphatic polyamide, in this case nylon, monofilaments with a count equal to 140 tex, these two multifilament strands being twisted in a helix individually at 250 turns per metre in one direction and then twisted together in a helix at 250 turns per metre in the opposite direction. These two multifilament strands are wound in a helix around one another. As a variant, use could be made of a hooping filamentary reinforcing element comprising one multifilament strand made up of a spun yarn of aliphatic polyamide, in this case nylon, monofilaments with a count equal to 140 tex, and one multifilament strand made up of a spun yarn of aromatic polyamide, in this case aramid, monofilaments with a count equal to 167 tex, these two multifilament strands being twisted in a helix individually at 290 turns per metre in one direction and then twisted together in a helix at 290 turns per metre in the opposite direction.

These two multifilament strands are wound in a helix around one another. As another alternative, use could be made of a hooping filamentary reinforcing element comprising two multifilament strands, each made up of a spun yarn of aromatic polyamide, in this case aramid, monofilaments with a count equal to 330 tex, and one multifilament strand made up of a spun yarn of aliphatic polyamide, in this case nylon, monofilaments with a count equal to 188 tex, each of the multifilament strands being twisted in a helix individually at 270 turns per metre in one direction and then twisted together in a helix at 270 turns per metre in the opposite direction. These three multifilament strands are wound in a helix around one another.

In general, the use of a high load leads to a reduction in the acceptable limit speed of the tyre and also a deterioration of its behaviour, for example its cornering stiffness. Thus, by using one or more high-modulus hooping filamentary reinforcing elements, for example like those described in the last two variants above comprising one or more aromatic polyamide strands, it is possible to increase the acceptable limit speed for the tyre and to improve the behaviour, in particular its cornering stiffness.

Each working filamentary reinforcing element is an assembly 4.26 of four steel monofilaments, comprising an internal layer of two monofilaments and an external layer of two monofilaments wound together in a helix around the internal layer at a pitch of 14.0 mm, for example in the S direction. Such an assembly 4.26 has a force at break equal to 640 N, a diameter equal to 0.7 mm. Each steel monofilament has a diameter equal to 0.26 mm and a mechanical strength equal to 3250 MPa. As a variant, use could also be made of an assembly of six steel monofilaments having a diameter equal to 0.23 mm, comprising an internal layer of two monofilaments wound together in a helix at a pitch of 12.5 mm in a first direction, for example the Z direction, and an external layer of four monofilaments wound together in a helix around the internal layer at a pitch of 12.5 mm in a second direction, opposite to the first direction, for example the S direction.

As shown in FIG. 3, each carcass textile filamentary reinforcing element 360, 370 of each first and second carcass layer 36, 37 comprises an assembly of at least two multifilament strands 363, 364 and 373, 374. Each multifilament strand 363, 364, 373, 374 is selected from a polyester multifilament strand, an aromatic polyamide multifilament strand and an aliphatic polyamide multifilament strand, preferably selected from a polyester multifilament strand and an aromatic polyamide multifilament strand. In this instance, the assembly is selected from an assembly of two polyester multifilament strands and an assembly of a polyester multifilament strand and an aromatic polyamide multifilament strand, and in this case is made up of two PET multifilament strands, these two multifilament strands being twisted in a helix individually at 420 turns per metre in one direction and then twisted together in a helix at 420 turns per metre in the opposite direction. Each of these multifilament strands has a count equal to 114 tex such that the total count of the assembly is less than or equal to 475 tex and in this case equal to 228 tex.

Each carcass textile filamentary reinforcing element 360, 370 has an average diameter D1, D2, respectively, expressed in mm, such that D1≥0.90 mm and D2 0.90 mm, preferably D1≤0.85 mm and D2≤0.85 mm, and more preferably D1≤0.75 mm and D2≤0.75 mm, and such that D1≥0.55 mm and D2≥0.55 mm, preferably D1 0.60 mm and D2≥0.60 mm. In this case, D1=D2=0.62 mm.

### Comparative Tests

In order to demonstrate the advantage of the invention, the inventors simulated both the running of tyres and the tension of each carcass filamentary reinforcing element of these same tyres.

Simulation of Running Tests

For each of these tests, running similar to the load/speed performance test described in Annex VII of UN/ECE Regulation No 30 was simulated, but under even more demanding conditions, in particular with a greater load. Various tyres of the following sizes 255/40 R21, 235/60 R18 and 255/60 R18 were simulated such that:
the tyres are in accordance with the invention (designated by the references INV1, INV2, INV3),
the tyres comprise first and second carcass layers arranged not in accordance with the invention such that each axial end of the second carcass layer is arranged axially on the outside of each axially outer portion of the first carcass layer (designated by the references COMP1, COMP2, COMP3).

During these simulations, the maximum volumetric energy dissipation DNRJ of a portion of the calendering matrices of the first and second carcass layers was recorded, this portion being situated axially between the first and second carcass layers and in the sidewall, and expressed in daN/mm2. The higher this value, the greater the energy dissipation by the tyre structure and the greater the rise in temperature. The results of these simulations are collated in Table 1 below.

TABLE 1

| | Dimension | | | | | |
|---|---|---|---|---|---|---|
| | 255/40 | 255/40 | 235/60 | 235/60 | 255/60 | 255/60 |
| | R21 | R21 | R18 | R18 | R18 | R18 |
| H | 102 | 102 | 141 | 141 | 153 | 153 |
| Tyre | INV1 | COMP1 | INV2 | COMP2 | INV3 | COMP3 |
| designation | | | | | | |
| DNRJ | 0.038 | 0.06 | 0.005 | 0.009 | 0.005 | 0.01 |

Note that the particular arrangement of the carcass reinforcement is necessary for reducing the energy dissipation and that an arrangement in which each axial end of the second carcass layer is arranged axially on the outside of each axially outer portion of the first carcass layer leads to an increase in energy dissipation. That is particularly advantageous for sidewall heights H≤130, preferably H≤120 and more preferably H≤110. Specifically, for such sidewall heights, since the maximum volumetric energy dissipation DNRJ is relatively high, the use of the invention makes it possible to significantly reduce the energy dissipation to an acceptable level in terms of absolute value.

Even though the energy dissipation, in terms of absolute value, is less for sidewall heights greater than 130 than for sidewall heights less than or equal to 130, the invention nevertheless makes it possible to reduce this energy dissipation by approximately 50%.

Tensioning Simulation

For each of these tests, the tension of each carcass filamentary reinforcing element was simulated for tyres inflated to a pressure equal to 2.8 bar and subjected to a load much higher than that used for the load/speed performance test described in Annex VII of UN/ECE Regulation No 30.

Various tyres of the following sizes 235/60 R18, 255/60 R18 were simulated such that:
the tyres have an arrangement of the carcass reinforcement according to the invention (designated by the references INV2, INV3),
the tyres comprise a single carcass layer and are therefore not according to the invention (COMP2′, COMP3′).

The tension of each carcass filamentary reinforcing element is measured at the end of the single carcass layer for the tyres comprising a single carcass layer and at the end of the first carcass layer forming the winding around the circumferential reinforcing element of each bead for the tyres comprising two carcass layers.

The results of these simulations are collated in Table 2 below.

TABLE 2

| Size | 235/60 R18 | 235/60 R18 | 255/60 R18 | 255/60 R18 |
|---|---|---|---|---|
| H | 141 | 141 | 153 | 153 |
| Tyre | INV2 | COMP2′ | INV3 | COMP3′ |
| designation | | | | |
| Tension (daN) | 0.34 | 0.71 | 0.42 | 0.79 |

First of all, it is shown that the tension of the carcass filamentary reinforcing elements is significantly reduced in the case of tyres having first and second carcass layers, in contrast to the tyres having a single carcass layer.

It will especially be noted that, for a given number of carcass layers, the tension is all the greater, the taller the sidewall is. Thus, by limiting the sidewall height to values less than or equal to 155, the tensioning of the carcass reinforcement is reduced to a reasonable level.

Static Test

In order to illustrate the effect of straightening the sidewalls, which, although advantageous, is optional within the scope of the invention, FIG. 4 illustrates the result of a static compression test on a tyre of size 255/40R21, which is identical to the tyre described above but for which the ratio T2/A is equal to 1.04 (tyre illustrated on the left-hand side, in which T1=T2=224 mm) and the tyre described above for which the ratio T2/A is equal to 0.97 (tyre illustrated on the right-hand side). The load applied to each tyre is equal to 925 kg at a pressure of 250 kPa.

Note that the deflection of the left-hand tyre is much greater than the deflection of the right-hand tyre. Specifically, the distance DR1 from the axis of rotation R to the ground in the left-hand tyre is less than the distance DR2 from the axis of rotation R to the ground in the right-hand tyre.

Note in particular that the sidewalls of the right-hand tyre are radially straighter than the sidewalls of the left-hand tyre. This can be seen by comparing, at the same radial point on each sidewall, the distances DF1 and DF2 between the outer surface of the sidewall situated on the opposite side to the contact patch and the plane SA that is perpendicular to the axis of rotation R of the tyre and passes through the bearing face of the rim delimiting the axial width A of the rim. This can also be seen by comparing, at the same radial point on each sidewall situated in line with the contact patch, the distances DF1′ and DF2′ between the outer surface of the sidewall and the perpendicular plane SA. It will be observed that DF1>DF2 and that DF1′>DF2′.

The invention is not limited to the embodiments described above.

1.-15. (canceled)

16. A tire (11) for a passenger vehicle, the tire (11) comprising a crown (12), two beads (32), two sidewalls (30), each connecting each bead (32) to the crown (12), and a carcass reinforcement (34) anchored in each bead (32), the crown (12) comprising a crown reinforcement (16) and a tread (14), the carcass reinforcement (34) extending in each sidewall (30) and in the crown (12) radially on an inside of the crown reinforcement (16), the tire (11) being of the HIGH LOAD CAPACITY type according to standard ETRTO 2021,
wherein the tire (11) has a sidewall height H defined by H=SW×AR/100, where SW is a nominal section width and AR a nominal aspect ratio of the tire according to standard ETRTO 2019 such that 95≤H≤155, and
wherein the carcass reinforcement (34) comprises first and second carcass layers (36, 37), the first carcass layer (36) forming a winding around a circumferential reinforcing element (33) of each bead (32) such that an axially inner portion (3611, 3621) of the first carcass layer (36) is arranged axially on an inside of an axially outer portion (3612, 3622) of the first carcass layer (36) and such that each axial end (361, 362) of the first carcass layer (36) is arranged radially on an outside of each circumferential reinforcing element (33), and each axial end (371, 372) of the second carcass layer (37) is arranged radially on an inside of each axial end (361, 362) of the first layer (36) and is arranged axially between the axially inner portion (3611, 3621) and axially outer portion (3612, 3622) of the first carcass layer (36), or axially on an inside of the axially inner portion (3611, 3621) of the first carcass layer (36).

17. The tire (11) according to claim 16, wherein each axial end (371, 372) of the second carcass layer (37) is arranged axially between the axially inner portion (3611, 3621) and axially outer portion (3612, 3622) of the first carcass layer (36).

18. The tire (11) according to claim 16, wherein H≤130.

19. The tire (11) according to claim 16, wherein each first and second carcass layer (36, 37) is axially delimited by two axial edges (361, 362, 371, 372) of the carcass layer (36, 37) and comprises carcass textile filamentary reinforcing elements (360, 370) extending axially from one axial edge to an other axial edge of the carcass layer (36, 37) along a main direction forming an angle ranging from 80° to 90° in terms of absolute value with a circumferential direction (X) of the tire (11).

20. The tire (11) according to claim 16, wherein each axial end of the first carcass layer is arranged radially on an inside of an equator of the tire.

21. The tire (11) according to claim 20, wherein each axial end of the first carcass layer is arranged at a radial distance of less than or equal to 30 mm from a radially inner end of each circumferential reinforcing element of each bead.

22. The tire (11) according to claim 16, wherein the nominal section width SW ranges from 225 to 315, the nominal aspect ratio AR ranges from 25 to 55, and the tire has a nominal rim diameter ranging from 18 to 23 and a load index LI ranging from 98 to 116.

23. The tire (11) according to claim 16, wherein 0.88<H/LI<0.98.

24. The tire (11) according to claim 16, wherein the tire has a size and a load index LI selected from among the following sizes and load indexes: 225/55R18 105, 225/55ZR18 105, 205/55R19 100, 205/55ZR19 100, 235/45R21 104, 235/45ZR21 104, 285/45R22 116, 285/45ZR22 116, 245/40R19 101, 245/40ZR19 101, 255/40R20 104, 255/40ZR20 104, 245/40R21 103, 245/40ZR21 103, 255/40R21 105, 255/40ZR21 105, 265/40R21 108, 265/40ZR21 108, 255/40R22 106, 255/40ZR22 106, 275/35R21 105, 275/35ZR21 105, 285/35R21 108, 285/35ZR21 108, 295/35R22 111, 295/35ZR22 111, 275/35R23 108, 275/35ZR23 108, 325/30R21 111, and 325/30ZR21 111.

25. The tire (11) according to claim 16, wherein the crown reinforcement (16) comprises a working reinforcement (20) comprising a radially inner working layer (24) and a radially outer working layer (26) arranged radially on an outside of the radially inner working layer (24).

26. The tire (11) according to claim 25, wherein each working layer (24, 26) is axially delimited by two axial edges (241, 242, 261, 262) of the working layer (24, 26) and comprises working filamentary reinforcing elements extending axially from one axial edge to an other axial edge of the working layer (24, 26), substantially parallel to one another.

27. The tire (11) according to claim 26, wherein each working filamentary reinforcing element extends in a main direction forming an angle which, in terms of absolute value, is strictly greater than 10°, with a circumferential direction (X) of the tire (11).

28. The tire (11) according to claim 16, wherein the crown reinforcement (16) comprises a hoop reinforcement (22) that is axially delimited by two axial edges (281, 282) of the hoop reinforcement and comprises at least one hooping filamentary reinforcing element wound circumferentially in a helix so as to extend axially between the axial edges (281, 282) of the hoop reinforcement (22).

29. The tire (11) according to claim 28, wherein the or each hooping filamentary reinforcing element extends along a main direction forming an angle which, in terms of absolute value, is less than or equal than 10°, with a circumferential direction (X) of the tire (11).

30. A mounted assembly (10) comprising:
a mounting support (100) comprising a rim (200); and
a tire (11) according to claim 16, mounted on the rim (200).

31. The mounted assembly (10) according to claim 30, wherein, with the crown reinforcement (16) being arranged radially between the tread (14) and the carcass reinforcement (34) and comprising a working reinforcement (20) comprising at least one axially narrowest working layer (26), the axially narrowest working layer (26) having an axial width T2 expressed in mm, and the rim (200) having a rim width A according to standard ETRTO 2019 and expressed in mm, a ratio T2/A is such that T2/A≤1.00.

32. A passenger vehicle comprising at least one tire (11) according to claim 16.

33. A passenger vehicle comprising at least one mounted assembly (10) according to claim 30.
